(19) United States
(12) Patent Application Publication
(10) Pub. No.: US 2024/0373790 A1
(43) Pub. Date: Nov. 14, 2024

(54) AN APPARATUS AND METHOD FOR AUTOMATED REGULATION OF A MIXTURE IN A SEED WOMB

(71) Applicant: ASPALLI GREEN SUSTAINABLE ECOSYSTEM PRIVATE LIMITED, Raichur (IN)

(72) Inventor: Nagaveni ASPALLI, Raichur (IN)

(21) Appl. No.: 18/286,329

(22) PCT Filed: Apr. 9, 2022
(86) PCT No.: PCT/IB2022/053337

§ 371 Date: Oct. 10, 2023

(30) Foreign Application Priority Data
Apr. 11, 2021 (IN) 202141016919

(51) Int. Cl. A01G 7/04; A01G 31/02

(52) U.S. Cl. CPC A01G 7/04; A01G 31/02

(57) ABSTRACT

An apparatus 100 and method for automated regulation of a mixture in a seed womb is disclosed. Said apparatus 100 comprises a processing device 120 that is operatively coupled with a control device 110. Said processing device 120 comprising a one or more processors 202 that is configured to fetch and execute computer-readable instructions stored in a memory 204, and is configured generate a output data relating to the regulated composition of the mixture based, on a first input data, a second input data, and a regulating parameter. The control device 110 automatically regulates the mixture of the seed womb to obtain a final mixture, based on the output data received from the processing device 120. The apparatus 100 further comprises at least one of a security module that facilitates: the tracking of seed wombs during wild fire, theft, and climate change; and documentation.

### FIELD OF THE INVENTION

The present disclosure is generally related to seed wombs. The present disclosure is particularly related to an apparatus and method for automatically modifying and/or regulating composition of mixture used in seed wombs. The present disclosure is further related to security modules of the apparatus that enables the tracking of seed wombs during wild fire, theft, or the like, and facilitates documentation.

### BACKGROUND OF THE INVENTION

Global warming is at peak with high temperature rise, draught, expanding deserts, scanty rains, drying up of lakes, ponds, rivers and underground water levels. The effect of greenhouse gases such as carbon dioxide, methane and nitrous oxide are at alarming high rates. To reverse global warming, trees need to be grown immediately. Reforestation of the planet is the solution for global warming and to reverse the course of climate change. Forests are an important part of the global carbon cycle because trees and plants absorb carbon dioxide through photosynthesis. By removing these greenhouse gases from the air, forests function as terrestrial carbon sinks by storing large amounts of carbon. Therefore, an increase in the overall forest cover around the world would tend to mitigate global warming.

Common reforestation techniques include both natural and artificial methods: Natural regeneration methods include root suckering, stump sprouting or natural seeding. Artificial regeneration methods include aerial and ground seeding, machine planting and hand planting. Generally, seed balls and saplings are used in artificial regeneration method of reforestation. However, saplings may include certain disadvantages. Saplings cannot be implemented in large numbers because they are bulky and heavier. Further, sapling may not transportable in remote in accessible areas such as mountain peaks and deep troughs. Furthermore, saplings must be grown in a nursery for 6 to 12 months and need digging pits which is not possible. Hence, it is time consuming as well as costly and tedious.

An alternative solution to saplings is seed womb that enclose seeds within a container filled with a mixture. The seeds in the seed womb can remain alive, aerated for a long time, with impressive shelf life of more than a year. The seed womb can supply the required nutrients on rain fall or watering and also can also aid in germination of seeds while helping easy spread of roots. However, the conventional seed wombs include mixture that may not be customized based on the requirements automatically.

Further, the other major causes for global warming are de-forestation due to theft of commercial and high value trees and wild fire. There is no proper system in place to track and secure such causes.

There is, therefore, a need in the art for an apparatus and method for automatically modifying and/or regulating composition of mixture used in seed wombs and security modules of the apparatus that enables the tracking of seed wombs during wild fire, theft, or the like, and facilitates documentation.

### OBJECTS OF THE PRESENT DISCLOSURE

Some of the objects of the present disclosure, which at least one embodiment herein satisfies are as listed herein below.

It is an object of the present disclosure is to provide an apparatus and method for automatically modifying and/or regulating composition of mixture used in seed wombs during a planting, along with identifying the shape and size of the seed womb to be used.

It is an object of the present disclosure is to provide a security modules that enables the tracking of seed wombs during wild fire, theft, or the like, and facilitates documentation.

### SUMMARY OF THE INVENTION

An apparatus for optimizing and/or regulating a composition of a mixture pertaining to a seed womb based on one or more tested attributes is disclosed. Said apparatus comprises a processing device that is operatively coupled with a control device. The processing device receives plurality of input data, such as a first input data and a second input data. The first input data is related to an initial composition of the mixture and the second input data is related to one or more tested attributes selected from at least one of a target soil attribute, an atmospheric condition attribute and a seed attribute.

The processing device comprises one or more processors that is configured to fetch and execute computer-readable instructions stored in a memory. The processing device is configured to: receive a plurality of input data including a first input data and a second input data, said first input data being pertaining to an initial composition of the mixture, and said second input data being pertaining to a one or more tested attributes selected from at least one of a target soil attribute, an atmospheric condition attribute and a seed attribute; process the second input data by comparing the one or more tested attributes with a one or more pre-stored parameters to obtain a regulating parameter; and generate, using the first input data, based on the generated regulating parameter, an output data pertaining to the regulated composition of the mixture, said output data indicates an extent of alteration required in the initial composition, based on the regulating parameter, to achieve the regulated composition, and the shape and size of the seed womb.

The control device enables to automatically regulate the composition of the mixture of the seed womb to obtain a final mixture, which includes the regulated composition, based on the output data received from the processing device.

Further, the control device comprises a plurality of containers, one or more robotic arms, a weighing machine, and a mixing container. The plurality of containers accommodate one or more ingredients for regulation and/or optimization of the mixture. The one or more robotic arms enables the transfer of a pre-determined amount of the ingredients from the plurality of containers into a mixing container. The weighing scale that facilitating to measure the weight of each ingredients transferred. The mixing container that facilitating the mixing of the ingredients received from the plurality of containers to obtain the final regulated composition.

The composition of a mixture may include pre-defined quantities of one or more ingredients selected from at least one of a bio-compost, a micronutrient, a macronutrient, coco peat, a pigment, a plant hormone, a photoreceptor, a fertilizer, a moisture retainer, an anti-fungal agent, an anti-bacterial agent, anti-viral agent, a pest repellent, growth stimulating additive, etc. In an exemplary embodiment, the composition may include the bio-compost and the moisture retainer in a ratio of 1:1.

The method of optimizing and/or regulating a composition of a mixture pertaining to a seed womb is also disclosed.

The apparatus further comprises at least one of a security module that facilitates the tracking of seed wombs during wild fire, theft, climate change, or the like, and facilitates documentation. Said at least one security module is disposed in the seed womb.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates block diagram of an apparatus for automatically modifying and/or regulating composition of mixture used in a seed womb, in accordance with an embodiment of the present disclosure;

FIG. 2 illustrates an exemplary representation of a processing device of an apparatus for automatically modifying and/or regulating composition of mixture used in a seed womb, in accordance with an embodiment of the present disclosure.

FIG. 3 illustrates a flow diagram for regulating a composition of a mixture used in a seed womb, in accordance with an embodiment of the present disclosure.

FIG. 4 illustrates an exemplary system in which or with which embodiments of the present disclosure may be utilized, in accordance with embodiments of the present disclosure.

### DETAILED DESCRIPTION OF THE INVENTION

Throughout this specification, the use of the words “comprise”, “have”, “contain”, and “include”, and variations such as “comprises”, “comprising”, “having”, “contains”, “containing”, “includes”, and “including” may imply the inclusion of an element or elements not specifically recited. The disclosed embodiments may be embodied in various other forms as well.

Throughout this specification, the phrases “one or more”, “at least a”, “at least an”, and “at least one” are used interchangeably.

Throughout this specification, the use of the word “apparatus” is to be construed as a set of technical components that are communicatively associated with each other, and function together as part of a mechanism to achieve a desired technical result.

Throughout this specification, the use of the word “plurality” is to be construed as being inclusive of “at least one”.

Throughout this specification, the use of the words “communication”, “couple”, and their variations (such as communicatively) are to be construed as being inclusive of: one-way communication (or coupling); and two-way communication (or coupling), as the case may be, irrespective of the direction of arrows in the drawings.

Implementation of the apparatus and/or method of the disclosure can involve performing or completing selected tasks manually, automatically, or a combination thereof. Further, according to actual instrumentation of the apparatus and/or method of the disclosure, several selected tasks could be implemented by hardware, by software, by firmware, or by a combination thereof using an operating system.

Also, it is to be noted that embodiments may be described as a process depicted as a flowchart, a flow diagram, a dataflow diagram, a structure diagram, or a block diagram. Although a flow chart describes the operations as a sequential process, many of the operations may be performed in parallel, concurrently, or simultaneously. In addition, the order of the operations may be re-arranged. A process may be terminated when its operations are completed, but may also have additional steps not included in the figure(s).

The present disclosure is related to an apparatus and method for automatically modifying (optimizing) and/or regulating composition of mixture used in seed wombs based on one or more tested attributes pertaining to at least one of a target soil, climatic conditions, and/or attributes related to seeds. The performance properties of the seed wombs can be greatly enhanced by modifying and/or regulating the composition of seed womb mixture based on the tested attributes.

In an embodiment of the present disclosure, the phrase “seed womb” to be construed as an enclosure or container including one or more seeds and a mixture, wherein the seed womb may protect the seeds from varying environmental conditions such as heat, wind and pests. The seed womb also help in keeping the seeds alive and help the germination of the seeds. The mixture in the seed womb may be biodegradable and the seed wombs may be spread or thrown on open lands, mountains, forests, along the banks of water bodies and the like, easily with low cost. The seed wombs can be dropped using flying vehicles such that even upon dropping from a height, the seed wombs may not break. The seed womb can provide all the required nutrients and creates conducive environment for the seeds to germinate and grow as a plant, upon raining or watering. The seed wombs can hold the seeds until they germinate, grow as a plant and strong roots develop. The seed womb can include a bottom configuration covered with a mesh of the seed womb that can help roots to get attached to the soil easily. The seed womb may be of different sizes, shapes, configuration and characteristics. Such seed wombs are disclosed in Indian applications Ser. No. 201841023526, 201843030596, and 201843035566. The seed womb may not be restricted by its size, shape, configuration and characteristics, and various types of seed womb may be customized using the apparatus and method of the present disclosure.

The apparatus and the method of the present disclosure can enable optimization and/or regulation of the composition of mixture used in the seed womb based on one or more tested attributes. The tested attributes may be related to at least one of a target soil, climatic conditions, and/or attributes related to seeds. The tested attributes enable to identify the nutrient deficiencies and/or essential elements to improve the performance of the seed wombs. The composition of mixture used in the seed womb can be optimized and/or regulated accordingly to compensate the missing nutrients and/or elements.

An apparatus 100 for optimizing and/or regulating a composition of a mixture pertaining to a seed womb based on one or more tested attributes, in accordance with an embodiment of the present disclosure is illustrated in FIG. 1. As illustrated in FIG. 1. As shown in FIG. 1, the apparatus 100 comprises a processing device 120 that is operatively coupled with a control device 110. The processing device 120 receives plurality of input data 130, such as a first input data and a second input data. The first input data is related to an initial composition of the mixture and the second input data is related to one or more tested attributes selected from at least one of a target soil attribute, an atmospheric condition attribute and a seed attribute.

The analysis of: the first input data enables to understand existing components of the mixture; and the second input data enables to understand the characteristics of any or a combination of soil at the target location, an atmospheric condition at the target location and seeds that May be confined within the seed womb. The analysis enables to optimize and/or regulate the nutrients and/or elements that can be added to the mixture to customize the seed wombs accordingly. It may be appreciated that using the apparatus 100 and method of the present disclosure, a seed womb mixture that may be produced in bulk with essential nutrients and/or elements can be easily and automatically customized based on varied demand on the soil of a target location, atmospheric condition of the target location and type of seeds used, apart from customizing the shape and size of the seed womb.

For example, the following table illustrates the ideal soil parameters for Raichur, Karnataka, India.

| | | Medium Or | |
|---|---|---|---|
| Parameters | Low | Normal | High |
| pH | <6.3 | 6.3-8.3 | >8.3 |
| EC (Electrical Conductivity) | | <1 | 1-4 |
| (measure of amount of salts in soil) | | | |
| N (Kg/ha) | <112 | 112-224 | >224 |
| P2O5(Kg/ha) | <9 | 9-23 | >23 |
| K205 (Kg/ha) | <56 | 56-134 | >134 |

Generally, the ideal pH range in soil is between 6.0 and 7.0. High pH in the soil prevents the iron present in the soil from changing into a form the plant can absorb.

EC is the measure of total dissolved salts in a solution, the factor that influences a plant's ability to absorb water. Optimal EC levels in the soil therefore range from 110-570 milliSiemens per meter (mS/m). In general, higher EC hinders nutrient uptake by increasing the osmotic pressure of the nutrient solution, wastes nutrients, and the increases discharged of nutrients into the environment, resulting in environmental pollution. Lower EC may severely affect plant health,

In sandy soils, the best balance is achieved by a “Moderate” soil nitrogen supply (25-50 mg-N/kg soil). In contrast, in loam and clay soils “High” soil nitrogen supply is most suitable (50-75 and 75-125 mg-N/kg soil respectively).

The buildup of phosphorus can cause plants to grow poorly and even die. Excessive soil phosphorus reduces the plant's ability to take up required micronutrients, particularly iron and zinc, even when soil tests show there are adequate amounts of those nutrients in the soil.

Similarly, higher levels of potassium are needed in soils high in clay and organic matter; lower levels in soils, which are sandy and low in the organic matter. Optimum levels for light-colored, coarse-textured soils may range from 100 to 150 ppm.

The water parameters are illustrated in the below table.

| | | Medium or | |
|---|---|---|---|
| Parameters | Low | Normal | High |
| RAINFALL | <2.5 mm/hr | 2.5 mm to | >7.6 mm/hr |
| | | 7.6 mm/hr | |
| PH | | 6.5-8.4 | |
| EC | <0.25 | 0.25-3 | >3 |
| RSC | <1.25 | 1.25-2.5 | >2.5 |
| (Residual Sodium Carbonate) | | | |
| Sodium Arborate | <6 | 6-9 | >9 |
| ESP (Exchangeable Sodium | <3 | 3-6 | >6 |
| Percentage) | | | |
| Chloride ppm | <142 | 142-355 | >355 |
| Sulfide ppm | <192 | 192-480 | >480 |
| Boron | <0.5 | 0.5-2 | >2.6 |

The climatic conditions classified globally are tropical, dry, temperate, cold, and polar. In India climatic zones are namely, hot-dry, warm-humid, temperate, and cold, and one sub-group namely composite.

Further, the soil types in India have been, on the basis of genesis, colour, composition and location, classified into: Alluvial soils, Black soils, Red and Yellow soils, Laterite soils, Arid soils, Saline soils, Peaty soils, and Forest soils.

The apparatus 100 shall comprises a pre-stored parameters with related values for each parameters, for different conditions, as explained above. Said pre-stored parameters shall include, but are not limited to, soil parameters, atmospheric and/or climate parameters, and seed attributes.

The seed womb mixture prepared by the apparatus 100 for the target location Raichur, Karnataka, India is as follows:

The target location is deficient in nitrogen content from slight to moderate levels; temperature is high (24° C.-44° C.) and low rainfall (500 mm-600 mm).

Hence, the mixture shall be like: 45 wt % Biocompost, 45 wt % Micro-retaining Component, 5 wt % Azospirillum, and 5 wt % Trichoderma.

The seed womb mixture prepared by the apparatus 100 for the target location Coorg, Karnataka, India is as follows:

The target location has fertile red loamy soil, and is shallow water clogged leached laterite areas, sloppy soil, and heavy rainfall of 2500-3500 mm.

Hence, the mixture shall be like: 90 wt % biocompost, 5 wt % moisture retaining component, 2 wt % trichoderma, and 3 wt % disease prevention agents (fungal, bacterial, viral, etc.)

The seed womb mixture prepared by the apparatus 100 for the target location Thar Desert, Rajasthan, India is as follows:

The target location has Rainfall of very less 100 mm to 500 mm, and temperature rises as high as 52 degrees Celsius.

Hence, the mixture shall be like: 20 wt % Biocompost, 70 wt % moisture retaining component, 2 wt % Azospirillum, 5 wt % Organic matter, and 3 wt % neem cake (disease prevention).

The seed attributes such as, weight, stamina, vigour nativity etc., are consider by the apparatus 100, to select the suitable seeds/stem/roots for reforestation, depending on the situations.

In another embodiment of the present disclosure, the present disclosure enables to optimize and/or regulate the existing mixture of the seed womb. However, the apparatus 100 and method cannot be limited to customization of existing mixture of seed wombs, but may also be implemented to newly prepare an optimized and/or regulated mixture for seed wombs.

In yet another embodiment of the present disclosure, the control device 110 comprises a detection unit that receives the initial mixture of the seed womb and detects an initial composition of the mixture to generate the first input data. Alternatively, the first input data may be determined by an external device. Further, based on the second input data, the processing device 120 determines a regulating parameter. The regulating parameter indicate the deficiencies in the tested attributes when compared to the pre-stored parameters, that means an extent of alternation required in the initial mixture composition, based on the regulating parameter. The regulating parameter may also indicates the shape and size of the seed womb.

The processing device 120 generates, an output data using the first input data and based on the regulating parameter. The output data is related to the regulated composition of the mixture, wherein the regulated composition indicates the modification needed in the initial composition of the mixture based on the tested attributes. The output data is transmitted to the control device 110 to automatically regulate the composition of the mixture to obtain a final mixture including the regulated composition. The final mixture may be suitable with respect to the soil of the target location, atmospheric condition of the target location and/or the seeds that may be added to the seed womb. The output data further includes the shape and size of the seed womb to be used.

In yet another embodiment of the present disclosure, the second input data is at least one of a target soil attributes, climatic conditions, and/or attributes related to seeds. The target soil data is related to the target soil attribute and is obtained by a soil testing device. The soil testing device may be any one of an in-built device in the apparatus 100 or an external device coupled with the apparatus 100. Alternatively, the soil testing may be done remotely and the target soil attribute may be obtained from a remote device. The target soil data may be obtained by testing a sample of a target soil that is pre-determined to interact with the seed womb.

In yet another embodiment of the present disclosure, the target soil attribute may include, but is not limited to, soil nutrient information, soil quality, nature of additives present in the target soil, a moisture content, pH, electro-conductivity, temperature and granularity. The nutrient information may be related to any or a combination of one or more macronutrients and micronutrients present in the target soil sample, such as, for examples, amount of potassium, nitrogen and phosphorus. The additives may be tested to identify the presence of beneficial or harmful additives in the soil. The above mentioned attributes may enable to understand the growth environment that the seed womb is subjected to, upon coming in contact with the target soil, wherein based on the deficiencies in the target soil, appropriate nutrients can be added to the seed womb to improve the chances of survival, germination or growth of plants. For example, in case of a soil sample that is found to be deficient in moisture, the regulation may take into account the addition of moisture retainers.

In yet another embodiment of the present disclosure, the atmospheric condition data is related to the atmospheric condition attribute. The atmospheric condition data may be obtained by at least one of a sensor and an external database. The sensors may be disposed at the target location to sense the atmospheric condition attribute selected from at least one of moisture, humidity, and dew point. The atmospheric condition attribute may be obtained from the external database that may include updated information regarding the forecast of the target location where the seed womb may be used, weather prediction of the target location and other micro climatic condition or macroclimatic condition.

In yet another embodiment of the present disclosure, the seed data is related to the seed attribute that may be added to the seed womb. The seed data may be obtained by testing one or more seeds that are pre-determined to be accommodated in the seed womb. The testing may be performed by an inbuilt device or by an external device. The seed attribute may include at least one of a seed type, one or more conditions essential for germination of seed and susceptibility to soil, external conditions or chemical agents.

In yet another embodiment of the present disclosure, the regulating parameter is related to an extent of regulation needed in the initial composition of the mixture to obtain the regulated composition. The specific amount of the ingredients to be added is determined by combining data related to the regulating parameter and the initial composition of mixture that may indicate the modification needed in the initial composition of the mixture based on the tested attributes to obtain the regulated composition. The output data from the processing device 120 may enable the control device 110 to add the one or more ingredients in the mixture of the seed womb.

In yet another embodiment of the present disclosure, the addition of ingredients may be entirely automated. In an exemplary embodiment, the control device 110 comprises a plurality of containers, one or more robotic arms and a mixing container. The plurality of containers accommodate one or more ingredients for regulation and/or optimization of the mixture. The mixing container accommodate a pre-determined amount of a standard mixture of a seed womb that may require to be regulated. Based on the output data that indicates the extent of regulation needed in the mixture, the robotic arms of the control device enables the transfer of a pre-determined amount of the ingredients from the plurality of containers into the mixing container. The resultant mixture is mixed automatically in the mixing container for a pre-determined time to obtain the final regulated composition. The control device 110 is configured with a weighing scale or a measuring scale at the robotic arm, at the mixing container or any such components of the mixer, said weighing scale facilitates to measure the weight of each ingredients. The control device 110 is also configured to automatically fill the seed womb with the regulated mixture. In another exemplary embodiment, the control device 110 can obtain a fresh mixture from the plurality of ingredients.

### EXAMPLES 1

### Raichur, Karnataka, India

Climatic conditions: Temperature of 30° C.-35° C.

Seed: Tamarind Seed

Soil Parameters: pH is 7.4, EC is 0.76 Ds/m (normal), nitrogen 51.5 kg/acre (deficient), P₂O₅ is 9.9 (Moderate), Potash is 72.6 kg/acre,

Water Parameter: Normal Ph water

The Final Mixture by the Apparatus is: Biocompost and Moisture Retaining Components (Coco peat Etc)—1:1; Trichoderma—1.5 to 2 wt %; and Neem Cake—1.5-5 w %.

Seed womb size of 6 cm to 8 cm diameter with water reservoir would be preferred.

### EXAMPLE 2

### Thar Desert, Rajasthan, India

Climate Condition: High Temperature with Less Water, Less rainfall,

Soil Condition: Deficiency of Nitrogen

Seed: Tamarind Seed

The Final Mixture by the Apparatus is: Biocompost and Moisture Retaining Components (Coco peat Etc)—1:2; Trichoderma 1.5 w %-2 w %; Azospirulum; 2 w %-5 wt % (Nitrogen fixing, biofertilizer and photoprotector); and Neem cake-5 to 10% wt %.

Seed Womb size preferred is 8 cm to 13 cm diameter or higher with water reservoir variant.

In yet another embodiment of the present disclosure, the initial composition and the regulated composition are related to pre-defined quantity of the ingredients. The ingredient may be selected from at least one of a bio-compost, a micronutrient, a macronutrient, coco peat, a pigment, a plant hormone, a photoreceptor, a fertilizer, a moisture retainer, an anti-fungal agent, an anti-bacterial agent, anti-viral agent, a pest repellent, an herbicide and a growth stimulating additive.

In yet another embodiment of the present disclosure, the moisture retainer may be at least one of a granular material, a chemical compound, a natural fibre and a powder. The growth stimulating additive may be at least one of a nano carbon based additive, silver based additive, silicon additive, nanosized metal, and nano-aluminosilicate. The ingredients or additives may be used to enhance germination, healthy growth of plants, prevention of diseases, to boost growth, to improve disease resistance, to improve fertility, enhance pest control and the like so as to achieve desired targeted action or desired type of seed womb based on the target soil characteristics.

In yet another embodiment of the present disclosure, the final composition may include the bio-compost and the moisture retainer in a ratio of 1:1. Various other factors related to nano technology, genetic engineering, efficient germination techniques and growth of seeds may be considered in the regulation of composition. The ingredients may include atmospheric water generator, hygroscopic materials, desiccants, coolants and other such moisture retainers or inhibitors.

In yet another embodiment of the present disclosure, the structure, size and design of seed womb may be modified to incorporate the ingredients for effective regulation. The final mixture may include: azospirillum to improve nitrogen absorption; phosphate solubilizing bacteria to improve phosphorus content; fungus such as Vesicular Arbuscular Mycorrhizal to improve potassium content; Indole acetic acid to stimulate plant growth; and bio fungicide such as trichoderma to allow strong root development and protection.

In yet another embodiment of the present disclosure, the ingredients may be present in a solid, liquid, gel and other such forms within the seed womb. The seed womb may include a container that may be filled with sufficient quantity of the mixture in a loose or compact manner in which one or more seeds may be dispersed. Alternatively, different layer of mixture may be present within a seed womb such that each layer may vary in ingredients and/or compactness and/or thickness based on the property of the target soil. As an example, in case of a lesser nutrient containing target soil, one or more seeds may be placed in the seed womb inside a nutrient rich bio-compost. In another example, the soil may be very dry, in such case the seed womb may include moisture retainer, additives as well as a configuration that allows entry of water from top of the seed womb. One may appreciate that the modification/regulation may not be restricted to change/regulation in the composition but also the configuration of the seed womb may be varied based on the tested attributes or characteristics.

In yet another embodiment of the present disclosure, the processing device 120 may be implemented as one or more microprocessors, microcomputers, microcontrollers, digital signal processors, central processing units, logic circuitries, and/or any devices that process data based on operational instructions. Among other capabilities, the one or more processor(s) 120 may be configured to fetch and execute computer-readable instructions stored in a memory of the apparatus 100. The memory may be configured to store one or more computer-readable instructions or routines in a non-transitory computer readable storage medium, which may be fetched and executed to create or share data packets over a network service. The memory may comprise any non-transitory storage device including, for example, volatile memory such as RAM, or non-volatile memory such as EPROM, flash memory, and the like. The processing engine may also be associated with a database that may comprise data either stored or generated as a result of functionalities implemented by any of the components of the processing engine(s) 120 of the apparatus 100. The database may also enable to store the pre-stored parameter that may include pre-set parameters of variety of soil samples for understanding attributes of the target soil with respect to a reference sample. In yet another embodiment of the present disclosure, the apparatus 100 provides a regulated composition of a seed womb. The composition may include pre-defined quantities of one or more ingredients selected from at least one of a bio-compost, a micronutrient, a macronutrient, coco peat, a pigment, a plant hormone, a photoreceptor, a fertilizer, a moisture retainer, an anti-fungal agent, an anti-bacterial agent, anti-viral agent, a pest repellent, growth stimulating additive etc.

In an exemplary embodiment, the regulated composition may include a mixture of moisture retaining components 25 w % to 75% wt; biocompost—25 w % to 75%; Trichoderma 2 w %-3 wt %; Azospirillum—0.2 w 5-5%; Azotobacter 0.2 w %-5%; Rhizobacteria 0.2 w %-5%; PSB-2 gm/kg—provides phosporus; Neem cake-disease prevention/organic matter—2 w %-10%; Metarhizium—2-5 gms/kg—pest control; IAA 0.2 w %-5%; and VAM 0.2 w %-5%.

In yet another embodiment of the present disclosure, the ingredients may be added by the control device 110 to the initial composition of the mixture to obtain a regulated composition of a seed womb. The seed womb so obtained can be modified in several aspects such as shape, size, number of seeds, composition and the like. Further, the seed womb may be designed based on an occasion. For example, the seed womb may be obtained in shape of divine deities, symbols, shapes, toy-shaped and the like, based on the occasion at which seed wombs may be desired to be planted. Several other customizations of seed womb are possible.

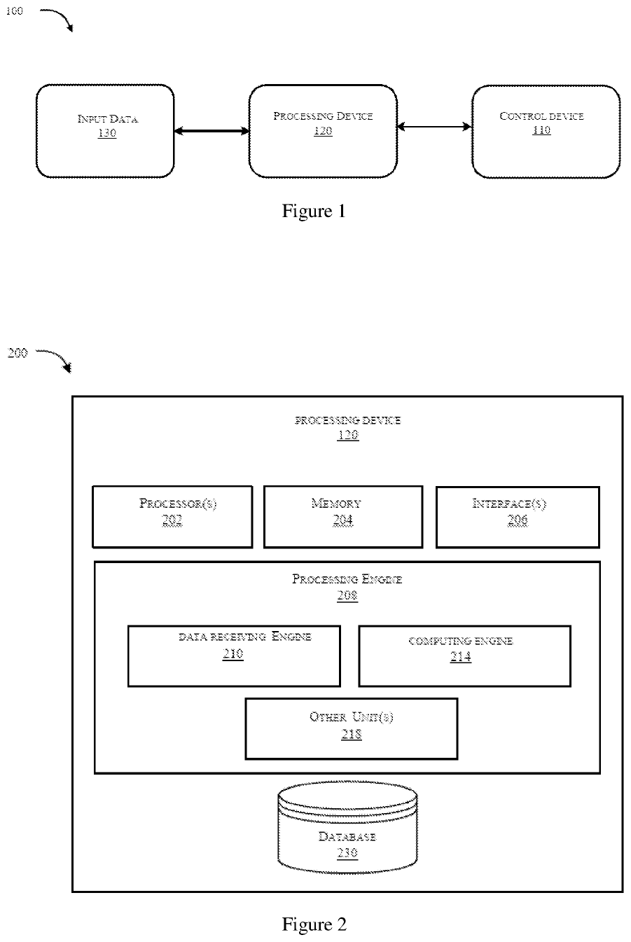

FIG. 2 illustrates an exemplary representation 200 of a processing device 120, in accordance with an embodiment of the present disclosure. The processing device 120 may receive a first input data and a second input data. The first input data pertains to an initial composition of the mixture and the second input data pertains to one or more tested attributes selected from at least one of a target soil attribute, an atmospheric condition attribute and a seed attribute. The processing device 120 may process the second input data to obtain a regulating parameter, wherein the second input data is processed to compare a one or more tested attributes with a one or more pre-stored parameters. The processing device 120 may generate, using the first input data, based on the generated regulating parameter, an output data pertaining to the regulated composition of the mixture. The output data indicates an extent of alteration required in the initial composition, based on the regulating parameter, to achieve the regulated composition, apart from the shape and size of the seed womb.

The one or more processors 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory 204 of processing device 120. The memory 204 may store one or more computer-readable instructions or routines, which may be fetched and executed to create or share the data units over a network. The memory 204 may comprise any non-transitory storage device including, for example, volatile memory such as RAM, or non-volatile memory such as EPROM, flash memory, and the like.

The processing device 120 may also comprise an interface(s) 206. The interface(s) 206 may comprise a variety of interfaces, for example, interfaces for data input and output devices, referred to as I/O devices, storage devices, SCADA, Sensors and the like. The interface(s) 206 may facilitate communication of the processing device 120 with various devices coupled to it. The interface(s) 206 may also provide a communication pathway for one or more components of the processing device 120. Examples of such components include, but are not limited to, processing engine(s) 202 and database 230.

The one or more processors 202 may be implemented as a combination of hardware and programming (for example, programmable instructions) to implement one or more functionalities of the one or more processors 202. In examples described herein, such combinations of hardware and programming may be implemented in several different ways.

For example, the programming for the one or more processors 202 may be processor executable instructions stored on a non-transitory machine-readable storage medium and the hardware for the one or more processors 202 may comprise a processing resource (for example, one or more processors), to execute such instructions.

In the present examples, the machine-readable storage medium may store instructions that, when executed by the processing resource, implement the one or more processors 202. In such examples, the processing device 120 may comprise the machine-readable storage medium storing the instructions and the processing resource to execute the instructions, or the machine-readable storage medium may be separate but accessible to the centralized server 112 and the processing resource. In other examples, the one or more processors 202 may be implemented by electronic circuitry. In an aspect, the database 230 may be configured to store any data including, but not limited to, at least one of the pre-stored parameters, tested attributes and the composition related data. In another aspect, the database 230 may comprise data that may be either stored or generated as a result of functionalities implemented by any of the components of the processor 202 or the processing engines 208. In an exemplary embodiment, the processing engine(s) 208 may include a data receiving engine 210, a computing engine 212 and other engines 214, wherein the other engines 220 may further include, without limitation, input reminder engine, storage engine, or signal generation engine. The data receiving engine 210 may obtain first input data and/or the second input data. The computing engine 212 may process received data to obtain the regulating parameter and the output data.

In yet another embodiment of the present disclosure, the apparatus 100 further comprises at least one of a security module that facilitates the tracking of seed wombs during wild fire, theft, climate change, or the like, and facilitates documentation. Said at least one security module is disposed in the seed womb. The security module may comprises plurality of sensors. Said plurality of sensors facilitates to track and detect: wild fire, location of the seed womb, environmental parameters, condition of seed womb, or the like. The information shared by the at least one security module to the apparatus are documented and used for future references and analysis.

In yet another embodiment of the present disclosure, the plurality of sensors include, but are not limited to, location sensor, sensor to monitor climate changes, smoke and fire sensor, moisture sensor, rain sensor, remote sensing, humidity sensor, etc.

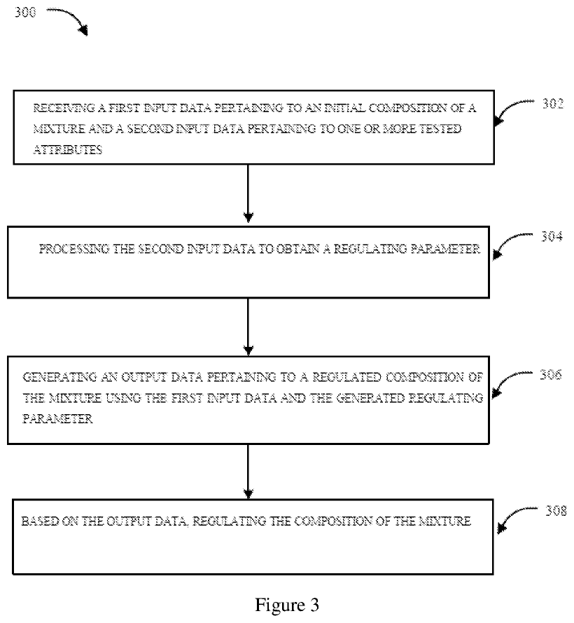

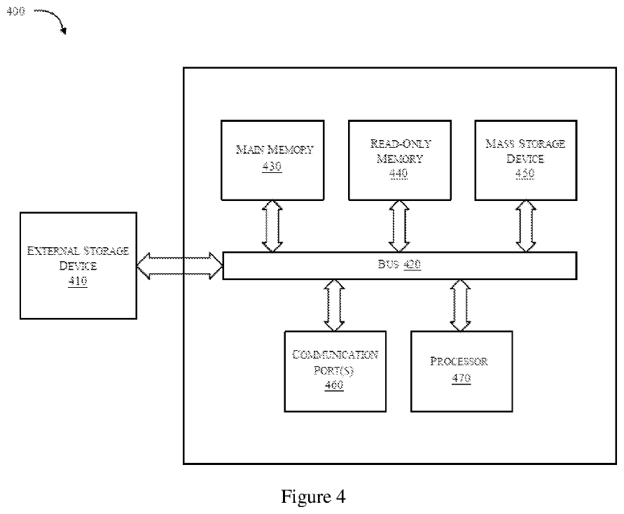

FIG. 3 illustrates a flow diagram 300 for regulating a composition of a mixture pertaining to a seed womb based on target soil testing, in accordance with an embodiment of the present disclosure. At 302, the method includes receiving, by a processing device 120, a first input data and a second input data. The first input data pertains to an initial composition of the mixture and the second input data pertains to one or more tested attributes selected from at least one of a target soil attribute, an atmospheric condition attribute and a seed attribute. At 304, the method includes processing, at the processing device 120, the second input data to obtain a regulating parameter. The input data may be processed to compare the one or more tested attributes with a pre-stored parameter. At 306, the method includes generating, at the processing device, using the first data, based on the generated regulating parameter, an output data pertaining to the regulated composition of the mixture. The output data indicates an extent of alteration required in the initial composition, based on the regulating parameter, to achieve the regulated composition. At 308, the method includes receiving, by a control device, the output data to automatically regulate the composition of the mixture of the seed womb to obtain a final mixture, which includes the regulated composition.

In yet another embodiment of the present disclosure, a soil sample may be tested for soil attribute: pH=7.41 (neutral); electro-conductivity=0.76 (normal); nitrogen content=5.15% (less), P2O5 content=9.9 (moderate). Based on the detected soil attribute and other attributes, the regulating parameter may be determined.

In yet another embodiment of the present disclosure, the present disclosure is related to a regulated composition of a seed womb facilitated by the method described above. The composition may include pre-defined quantities of one or more ingredients selected from at least one of a bio-compost, a micronutrient, a macronutrient, coco peat, a pigment, a plant hormone, a photoreceptor, a fertilizer, a moisture retainer, an anti-fungal agent, an anti-bacterial agent, anti-viral agent, a pest repellent, an herbicide and a growth stimulating additive. In an exemplary embodiment, the composition may include the bio-compost and the moisture retainer in a ratio of 1:1.

In yet another embodiment of the present disclosure, the present disclosure is related to a seed womb comprising the regulated composition as described above.

FIG. 4 illustrates an overview 400 of an exemplary computer system in which or with which embodiments of the present invention can be utilized in accordance with embodiments of the present disclosure. As shown in FIG. 4, the computer system 400 can include an external storage device 410, a bus 420, a main memory 430, a read only memory 440, a mass storage device 450, communication port 460, and a processor 470. A person skilled in the art will appreciate that the computer system may include more than one processor and communication ports. Examples of processor 470 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 470 may include various modules associated with embodiments of the present invention. Communication port 460 can be any of an RS-232 port for use with a modem based dialup connection, a 10/100 Ethernet port, a Gigabit or 10 Gigabit port using copper or fiber, a serial port, a parallel port, or other existing or future ports. Communication port 460 may be chosen depending on a network, such a Local Area Network (LAN), Wide Area Network (WAN), or any network to which computer system connects. Memory 430 can be Random Access Memory (RAM), or any other dynamic storage device commonly known in the art. Read-only memory 440 can be any static storage device(s) e.g., but not limited to, a Programmable Read Only Memory (PROM) chips for storing static information e.g., start-up or BIOS instructions for processor 470. Mass storage 450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couples processor(s) 470 with the other memory, storage and communication blocks. Bus 420 can be, e.g. a Peripheral Component Interconnect (PCI)/15 PCI Extended (PCI-X) bus, Small Computer System Interface (SCSI), USB or the like, for connecting expansion cards, drives and other subsystems as well as other buses, such a front side bus (FSB), which connects processor 470 to software systems.

Optionally, operator and administrative interfaces, e.g. a display, keyboard, joystick and a cursor control device, may also be coupled to bus 420 to support direct operator interaction with a computer system. Other operator and administrative interfaces can be provided through network connections connected through communication port 460. The external storage device 410 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

The apparatus and method of the present disclosure thus provide an optimized and/or regulated seed wombs that can be spread or thrown on open lands, mountains, forests, along the banks of water bodies and the like easily with low cost, wherein they can be even dropped using aircraft. On raining or watering, the regulated seed wombs provide all the required nutrients and creates conducive environment for the seeds to germinate and grow as a plant. The seed wombs hold the seeds until they germinate, grow as a plant and strong roots develop. Diverse variety of seed wombs of forestry agriculture and horticulture can be made, such that a forest, garden or a farm to grow food can be grown easily, economically and rapidly.

The present disclosure provides an accurate and effective method of determining deficiencies of target soil such that depending on the deficiencies, the seed womb mixture characteristics can be modified.

The present disclosure provides a simple and efficient apparatus and method to enhance the characteristics of seed womb for better plantation outcome

It will be apparent to a person skilled in the art that the above description is for illustrative purposes only and should not be considered as limiting. Various modifications, additions, alterations and improvements without deviating from the spirit and the scope of the disclosure may be made by a person skilled in the art. Such modifications, additions, alterations and improvements should be construed as being within the scope of this disclosure.

We claim:

1. An apparatus for optimizing and regulating a composition of a mixture pertaining to a seed womb, comprising:
a processing device that is operatively coupled with a control device, said processing device comprising a one or more processors that is configured to fetch and execute computer-readable instructions stored in a memory, said processing device being configured to:
receive a plurality of input data including a first input data and a second input data, said first input data being pertaining to an initial composition of the mixture, and said second input data being pertaining to a one or more tested attributes selected from at least one of a target soil attribute, an atmospheric condition attribute and a seed attribute;
process the second input data by comparing the one or more tested attributes with a one or more pre-stored parameters to obtain a regulating parameter; and
generate, using the first input data, based on the generated regulating parameter, an output data pertaining to the regulated composition of the mixture, said output data indicates an extent of alteration required in the initial composition, based on the regulating parameter, to achieve the regulated composition, and the shape and size of the seed womb; and
the control device that facilitates to automatically regulate the composition of the mixture of the seed womb to obtain a final mixture, which includes the regulated composition, based on the output data received from the processing device.

2. The apparatus for optimizing and regulating a composition of a mixture pertaining to a seed womb as claimed in claim 1, wherein the control device comprising a detection unit that receives the initial mixture of the seed womb and detects an initial composition of the mixture to generate the first input data.

3. The apparatus for optimizing and regulating a composition of a mixture pertaining to a seed womb as claimed in claim 1, wherein the control device comprising:
a plurality of containers that accommodate one or more ingredients for regulation and/or optimization of the mixture;
one or more robotic arms that enables the transfer of a pre-determined amount of the ingredients from the plurality of containers into a mixing container;
a weighing scale that facilitating to measure the weight of each ingredients transferred; and
the mixing container that facilitating the mixing of the ingredients received from the plurality of containers to obtain the final regulated composition.

4. The apparatus for optimizing and regulating a composition of a mixture pertaining to a seed womb as claimed in claim 1, wherein the target soil attributes are obtained by a soil testing device, said soil testing device is either an in-built device in 15 the apparatus 100 or an external device coupled with the apparatus.

5. The apparatus for optimizing and regulating a composition of a mixture pertaining to a seed womb as claimed in claim 1, wherein the atmospheric condition data being obtained by disposing at least one sensor at the target location to sense the atmospheric condition and an external database.

6. The apparatus for optimizing and regulating a composition of a mixture pertaining to a seed womb as claimed in claim 1, wherein the regulating parameter indicate the extent of alternation required in the initial mixture composition to obtain the regulating mixture.

7. The apparatus for optimizing and regulating a composition of a mixture pertaining to a seed womb as claimed in claim 1, wherein the initial composition and the regulated composition arc related to pre-defined quantity of the ingredients, said ingredient being selected from at least one of a bio-compost, a micronutrient, a macronutrient, coco peat, a pigment, a plant hormone, a photoreceptor, a fertilizer, a moisture retainer, an anti-fungal agent, an anti-bacterial agent, anti-viral agent, a pest repellent, an herbicide and a growth stimulating additive.

8. The apparatus for optimizing and regulating a composition of a mixture pertaining to a seed womb as claimed in claim 1, wherein the apparatus comprising at least one of a security module that facilitates: the tracking of seed wombs during wild fire, theft, and climate change; and documentation, with: said at least one security module being disposed in the seed womb.

9. A method of optimizing and regulating a composition of a mixture pertaining to a seed womb, comprising the steps of
receiving a first input data and a second input data by the processing device, said first input data being pertaining to an initial composition of the mixture, and
said second input data being pertaining to a one or more tested attributes selected from at least one of a target soil attribute, an atmospheric condition attribute and a seed attribute;
processing the second input data by comparing the one or more tested attributes with a one or more pre-stored parameters to obtain a regulating parameter, by the processing device;
generating by the processing device, using the first input data, based on the generated regulating parameter, an output data pertaining to the regulated composition of the mixture, said output data indicates an extent of alteration required in the initial composition, based on the regulating parameter, to achieve the regulated composition, and the shape and size of the seed womb; and
receiving the output data, by the control device, to automatically regulate the composition of the mixture of the seed womb to obtain a final mixture.
